(19) United States
(12) Patent Application Publication
(10) Pub. No.: US 2007/0009384 A1
(43) Pub. Date: Jan. 11, 2007

(54) Apparatus for carrying out catalytic tests

(76) Inventors: Jens Klein, Heidelberg (DE); Robert Neubauer, Malsch (DE); Mario Hermann, Wiesloch (DE); Torsten Zech, Heidelberg (DE); Alexander Cross, Mainz (GB); Frank Guellich, Sandhausen (DE); Ralf Kuppinger, Plankstadt (DE); Oliver Koechel, Bubenheim (DE); Georg Vassiliadis, Worms (DE); Uwe Vietze, Eppelheim (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/566,497

(22) PCT Filed: Aug. 3, 2004
(86) PCT No.: PCT/EP04/08691

§ 371 Date: Aug. 22, 2006

(30) Foreign Application Priority Data
Aug. 6, 2003 (DE) 103 36 086.7

(51) Int. Cl. G01N 31/10

(52) U.S. Cl. 422/68.1

(57) ABSTRACT

Apparatus for simultaneously and/or successively carrying out at least two catalytic tests, having a reactor element, which includes at least one gas inlet unit, a plurality of reaction chambers and at least one restriction unit, the at least one restriction unit being configured in such a manner that it has a plurality of channels, which are arranged in such a manner that at least one reaction chamber is in direct contact with at least one channel of the at least one restriction unit.

The present invention relates to an apparatus for carrying out catalytic tests, in particular a reactor for high-throughput testing of potential catalysts, which is suitable, on account of its scalability, for testing a large number of catalysts by the use of a plurality of (at least two) analysis methods, preferably in parallel or in quick succession.

On account of their design, the reactors which have hitherto been disclosed by the literature are on the one hand only suitable for testing a limited number of catalysts in parallel or sequentially, and on the other hand the testing is generally carried out exclusively using just one analysis method either using IR thermography or, for example, mass spectrometry.

WO 97/32208 describes, for example, a reactor for IR-thermographic testing of heterogeneous catalysts. This reactor has a sapphire window in the cover, which allows simultaneous thermographic examination of in this case just 16 catalysts. The starting gas is metered in through four symmetrically arranged gas inlets near the bottom of the reactor. The four gas outlets are arranged in a similar way and are located close to the cover. The catalysts are placed approximately halfway between the gas inlet and gas outlet. They are arranged freely on an alumina disc.

This reactor is unsuitable for the use of other analysis methods apart from thermography, since the products of the individual catalysts cannot be selectively captured and analyzed. Furthermore, the flow conditions at each individual catalyst pellet are not sufficiently well defined to allow a more detailed analysis of the activity of the catalysts to be carried out. The alumina disc used as a support for all the catalyst pellets is less than optimum with regard to the intrinsic heat emission (emissivity) aspect. Minor temperature differences cannot be detected on account of the differences in emissivity. The range of applications for the reactor therefore remains restricted to the investigation of reactions, in particular highly exothermic reactions, such as for example hydrogen-oxygen reactions. Finally, on account of the relatively large gas space, there is the possibility of explosions in the case of potentially explosive mixtures.

DE 198 09 477 A1 describes a reactor for testing heterogeneous catalysts with a high throughput. The catalysts are located in separate channels, which are arranged in the form of a matrix and are at the same time exposed to the reaction gas. A central gas inlet for all the reactor channels is arranged at the top, on the reactor cover, and the outgoing streams from each reaction channel are passed separately to the bottom of the reactor, where they can be selectively actuated and analyzed.

This reactor model is suitable for the high-throughput testing of heterogeneous catalysts using analysis methods such as gas chromatography, mass spectrometry lo and other known spectroscopic methods. This reactor is unsuitable for the use of thermography, since the thermal radiation of the catalysts cannot be detected from the outside.

WO 99/34206 relates to a reactor which is similar to the reactor described in WO 97/32208. The gas is admitted from the side, and is also discharged from the side. The thermal radiation of the catalyst pellets can be detected through a suitable window in the cover. In this context, slate is used as a support plate material for all the catalysts.

In this case too, selective analysis of the products generated by a certain catalyst is not possible. The flow conditions at the catalyst material itself are likewise undefined in this context.

U.S. Pat. No. 4,099,923 describes a monolithic parallel reactor for the automated testing of heterogeneous catalysts. The reactor comprises six conventional test tubes, which are automatically and sequentially fed with reaction gas. The tubes have a common gas outlet, via which the product gas is fed for on-line analysis. The gas inlet design means that only one catalyst can be exposed to the starting gas at any one time. This arrangement is therefore unsuitable for catalysts which have an activation phase. Furthermore, this arrangement only allows the use of conventional valve circuits.

DE-A 27 14 939 relates to a tube bundle reactor used on an industrial scale with modified gas outlets. These outlets allow selective analysis of a product gas from a specific tube. Since the amount of catalyst material is very large, the reactor is unsuitable for rapid catalyst testing (catalyst screening). This arrangement is primarily only suitable for quality control. Furthermore, exact temperature monitoring is not possible, and nor is the use of thermography.

DD-A 234 941 describes a reactor structure having from 7 to 10 parallel channels which are heated by an external oven. This application is only suitable for reactions with a low exothermicity, and is not suitable for the use of IR thermography.

Creer, J. G. in Appl. Catal. 22 (1986), 85 describes a six-fold microreactor which comprises two reactor blocks, each of the six channels having a diameter of 6 mm. Each discharge gas stream can be analyzed separately with the aid of gas chromatography. However, in this case too it is not possible to use IR thermography.

Accordingly, the reactors disclosed hitherto are generally unsuitable, on account of their design, for testing a relatively large number of potential catalysts under identical conditions, in parallel or simultaneously, or using more than analysis method.

DE-A 100 12 847.5-52 merely provides a general description of an apparatus for combinatorial preparation and testing of material libraries through the use of at least two analysis methods. The measuring methods used for analysis described in that document are preferably IR thermography in combination with, for example, mass spectrometry, gas chromatography or other spectroscopic methods. Manufacturing technology limits mean that with this apparatus too it is not possible for a relatively large number of potential catalysts to be tested in parallel or simultaneously under identical conditions.

In view of the prior art outlined above, the invention was based on the object of providing an apparatus which, inter alia on account of its scalability and expansion options, is suitable for allowing the simultaneous or successive testing of a large number of catalysts using a combination of a plurality of analysis methods.

According to the invention, this object is achieved by an apparatus for simultaneously and/or successively carrying out at least two catalytic tests, having a reactor element, which includes at least one gas inlet unit, a plurality of reaction chambers and at least one restriction unit. The at least one restriction unit has a plurality of channels, which are arranged in such a manner that at least one reaction chamber is in direct contact with at least one channel of the at least one restriction unit.

The reactor element, the external form of which is not in principle subject to any particular constraints, may, for example, be in cylinder form. There are no particular constraints relating to the material used for the reactor element employed in accordance with the invention, provided that the materials used are able to withstand the loading to which the reactor element is exposed. It is preferable to use metals or metal alloys, such as for example brass, aluminium and stainless steels, e.g. those in accordance with DIN 1.4401, DIN 1.4435, DIN 1.4541, DIN 1.4571, DIN 1.4573, DIN 1.4575, DIN 2.4360/2.4366, DIN 2.4615/2.4617, DIN 2.4800/2.4810, DIN 2.4816, DIN 2.4851, DIN 2.4856, DIN 2.4858, DIN 1.4767, DIN 1.4401, DIN 2.4610, DIN 1.4765, DIN 1.4847, DIN 1.4301, as well as ceramics. It is particularly preferable for the reactor element to be produced from V2A or V4A steel.

In the reactor element, it is possible to provide recesses, the number, shape and orientation of which correspond to those of optional holding elements. In addition to these recesses, further recesses, which are preferably in the form of bores, are formed in the reactor element. Gas, for example, can be fed to the apparatus through these bores. It is also conceivable for gas to be discharged through these bores. Moreover, these recesses can be provided with valves, such as for example multiport valves.

A plurality of reaction chambers is located within the reactor element.

In the context of the present document, the term “channel” generally describes a connection between two openings, allowing, for example, a fluid to pass through regions of the reactor element or through the entire reactor element.

A channel may have a cross-sectional area which varies over its length or may preferably have a constant cross-sectional area. The channel cross section may, for example, have an oval, round or polygonal contour with straight or curved connecting lines between the corners of the polygon. However, it is preferable to use a round or regular polygonal cross section. The channels may have a straight and/or curved profile, but they preferably run along a straight longitudinal axis.

The reaction chambers are used in particular to hold the catalyst samples. For this purpose, the reaction chambers may be present in all configurations known to the person skilled in the art. They preferably have a round cross section.

It is also preferable for them to have special receptacles for the catalyst samples to be tested. These receptacles may, for example, form meshes made from a suitable material, allowing the potential catalysts which are to be tested to be held therein.

For their part, the reaction chambers are preferably in direct contact with at least one channel of the plurality of channels of the at least one restriction unit. For its part, the restriction unit is preferably in direct contact with the off-gas unit, so that the channels which are integrated therein preferably open out into at least one off-gas space of the off-gas unit.

The channels of the restriction unit may have all dimensions and configurations which appear possible to the person skilled in the art, for example round, oval or also polygonal cross sections of all technically feasible lengths and widths.

It is preferable for the channels of the restriction unit to have a round cross section in the context of the present invention.

In one embodiment of the present invention, these channels may furthermore have capillaries, in which context it is particularly preferable for a channel to have a capillary and for the corresponding capillary to be connected in a positively locking, i.e. gastight, manner at its upper end to the lower end of the corresponding reaction chambers.

The capillary may be in straight, i.e. elongate, curved or round form within the channel.

The capillaries may be made from any material known to the person skilled in the art for this purpose, or also from a plurality of materials, such as for example stainless steel, glass, ceramic, composite materials, silica and further oxidic materials.

In the context of the present invention, it is preferable to use stainless steel capillaries.

The capillaries may be of the configurations listed above in connection with the channels, and in the context of the invention it is preferable for the capillaries to be round in cross section.

The positively locking, i.e. gastight, connection between the upper end of the capillary and the lower end of the corresponding reaction chamber may be effected using all means with which the person skilled in the art will be familiar for this purpose, for example by screw connections, by using clamping rings, seals and swagelock screw connections, welding, orbital welding, soldering and pressing-together or pressing-in.

By using one or more of the options described above for connecting the upper end of the capillary to the lower end of the respective reaction chambers, it is possible for individual capillaries or all the capillaries to be exchangeably connected to the respective reaction chambers.

Accordingly, the present invention also relates to an apparatus as described above in which the at least one capillary is exchangeably connected to the at least one channel of the channels.

It is also possible for the restriction unit, which includes the channels and optionally the capillaries, to be integrated into the apparatus in such a manner that it can be exchanged as an entire unit, i.e. independently of the other parts of the apparatus.

The connection between the restriction unit and the apparatus units adjoining it, which allows this exchange option, can be effected using all means known to the person skilled in the art for this purpose, for example it is possible for the units to be connected by screw connection including seals (e.g. graphite, Teflon, metal), by pressing them together, by fitting clamps, by riveting, by bonding and by adhesion.

Accordingly, the present invention also relates to an apparatus as described above in which the at least one restriction unit can be exchanged independently of the other components of the apparatus.

It is also possible for a capillary of smaller diameter than the respective channel to be introduced into a channel, in which case the space between the inner wall of the channel and the outer wall of the capillary may preferably be sealed off in a gastight manner by means of a sealing medium and/or the capillary may be connected in a positively locking, i.e. gastight, manner at its upper end to the lower end of the corresponding reaction chamber.

In a further embodiment of the present invention, in which the capillaries are exchangeably connected to the reaction chambers, it is possible for a restriction unit to have capillaries which are identical or different in terms of their geometry (i.e. their length and/or their cross section).

In a further embodiment of the present invention, the capillaries project into the at least one off-gas space of the at least one off-gas element, and thereby prevent in particular a reaction of the outgoing product stream with the material of the heat distributor and/or the heating unit.

The channels, with or without introduced capillaries, which are arranged inside the restriction unit are used for the reaction gas to pass through and for restriction.

In the context of the present document, the term restriction is to be understood as meaning control of the reaction gas flowing out of the reaction chambers by means of the geometry of the channels and/or the capillaries located therein within the restriction unit.

It is therefore possible for the channels and/or the capillaries located therein to be used within the restriction unit for defined reaction gas routing.

The geometry of the individual channels and/or of the capillaries within the restriction unit can be used to control the pressure drop across the respective channels and/or capillaries and therefore the pressure loss within the corresponding reaction chambers.

A uniform geometry of the channels and/or capillaries within a restriction unit, in particular the identical cross section and length, therefore makes it possible to ensure a substantially identical pressure loss within all the reaction chambers, and therefore to achieve a uniform fluid distribution of the reaction gas above the catalyst samples located in the reaction chambers.

It is therefore possible, by using a uniform geometry of the channels and/or capillaries within a restriction unit, to ensure a substantially constant setting of a specific pressure within all the reaction chambers during the reaction of the catalysts to be tested with the reaction gas which has flowed in.

Accordingly, the present invention also relates to an apparatus as described above, in which the plurality of channels (20) have identical geometries, the geometry being determined at least by the length and the cross section of the channels (20).

Furthermore, the present invention also relates to an apparatus as described above in which at least one channel of the channels (20) has at least one capillary.

In a further embodiment of the present invention, in which the optionally exchangeable capillaries connected to the respective reaction chambers within a restriction unit have different geometries, it is possible to set different admission pressures within the reaction chambers during the reaction of the catalysts to be tested with the reaction gas which has flowed in.

This makes it possible, for example, to test the reaction of potential catalysts at different pressures or under different flows in parallel or in quick succession.

Accordingly, the present invention also relates to an apparatus as described above in which the plurality of channels (20) have different geometries, the geometry being determined at least by the length and cross section of the channels (20).

In the context of the present apparatus according to the invention, the geometry of the channels and/or capillaries may involve an internal diameter of the channels or capillaries in the range from 1 μm to 1000 μm; preferably 25 μm to 400 μm, particularly preferably 50 μm to 150 μm, and a length of the channels or capillaries in the range from 0.01 cm to 200 m, preferably 0.1 cm to 100 m, particularly preferably 5 cm to 20 m.

Of course, any conceivable combination of internal diameter and length is possible as the geometry of a channel or capillary.

Of course, the geometry of a channel and of the capillary optionally located therein may differ.

Therefore, it is also possible to carry out reactions under pressure, for example petrochemical reactions, such as Fischer-Tropsch synthesis, cracking, GTL (gas-to-liquid) reactions and isomerization reactions.

Accordingly, the present invention also relates to an apparatus as described above, which is configured in such a manner that the reactions of the catalysts to be tested with the reaction gas which has flowed in can be carried out within the reaction chambers under a superatmospheric pressure in a range from 1 to 100 bar, preferably 10 to 1 bar, particularly preferably 50 to 750 mbar.

In principle, there are no restrictions with regard to the geometry and dimensions of the reaction chambers. They may all have the same or different geometries and dimensions.

In general, the dimensions of the reactor chambers are selected in such a way that the risk of an explosion caused by mixing effects can be substantially ruled out even with potentially explosive gas mixtures and reactions carried out under pressure, thereby ensuring that the apparatus according to the invention works safely.

In one preferred embodiment, the geometry of the reaction chambers is covered by the general term “channel” used in the present document.

In the context of the present apparatus according to the invention, the internal diameter of the reaction chambers may be in a range from 0.1 to 1000 mm, preferably 1 to 50 mm, more preferably 4 to 10 mm.

In the context of the present apparatus according to the invention, the length of the reaction chambers may lie in a range from 0.1 to 100 mm, preferably 1 to 50 mm, more particularly preferably 10 to 30 mm.

A possible embodiment of the channels or capillaries within the restriction unit in accordance with the invention makes it possible to ensure a substantially uniform distribution of fluid even without absolute uniformity of the catalysts to be tested. Consequently, in addition to the standard configurations of the catalysts to be tested, such as compact shaped bodies of dimensions in the range from 0.001 to 10 cm³, preferably in the range from 0.01 to 1.0 cm³, particularly preferably 0.05 to 0.5 cm³, an apparatus according to the invention can also be used to test catalysts in the form of powder or granules of any desired size.

According to the invention, the apparatus has an IR (infrared)-transparent cover adjoining the reactor element on one side, which cover delimits the reaction chambers on one side, specifically the opposite side from the restriction unit.

Accordingly, the present invention also relates to an apparatus which has at least one IR-transparent cover.

This IR-transparent cover is preferably in disc form and may also be of multipart configuration. Multipart configurations of this nature may be embodied as a plurality of smaller covers.

In the context of the present apparatus according to the invention, the thickness of the IR-transparent cover may be in a range from 1 μm to 10 cm, preferably in a range from 10 μm to 1000 μm, particularly preferably in a range from 200 to 800 μm.

The materials used may in principle be any IR-transparent materials, but it is preferable to employ sapphire, zinc sulphide, barium difluoride, sodium chloride and/or silicon (for example in the form of a silicon wafer).

An apparatus construction of this type makes it possible for the thermal camera to be arranged outside the reactor element and therefore such that it is isolated from the reaction conditions.

It is particularly preferable for the IR-transparent cover for the plurality of reaction chambers with respect to a thermal camera used to be a silicon wafer or a sapphire disc.

Accordingly, the present invention also relates to an apparatus as described above, in which a silicon wafer is arranged between the plurality of reaction chambers an at least one thermal camera as an IR-transparent cover.

The apparatus according to the invention has at least one mask with a uniform IR emissivity between the reactor element and the IR-transparent cover. This mask is preferably received by a recess provided in the reactor element.

Accordingly, the present invention also relates to an apparatus as described above which has at least one mask with a uniform IR emissivity.

To ensure sufficient fluid-tightness between reactor element, mask and IR-transparent cover, it is additionally possible for seals to be provided between reactor element and mask and/or between reactor element and IR-transparent cover and/or between mask and IR-transparent cover. With regard to the sealing material, reference is made to the materials which have already been described above in connection with the sealing elements for isolating the reaction chambers.

However, this mask may in principle consist of all materials suitable for this purpose, which approximately have the properties of a “black-body radiator” (black body) and therefore prevent temperature artefacts resulting from differences in emissivity. By way of example, mention may also be made in this context of β-Si₃N₄ and graphite.

In the context of the present invention, it is preferable for slate to be used as the mask material.

This slate mask is preferably used to prevent temperature artefacts caused by differences in emissivity, which are generally caused by apparatus components heating up. This undesirable thermal radiation could distort the measurement of the temperature differences between the catalyst material and surroundings or inactive materials which it is actually intended to carry out, by being superimposed thereon.

The number, cross section and orientation of the openings in the slate mask preferably correspond to those of the reaction chambers.

In one preferred embodiment of the invention, the openings in the slate mask have round cross sections. It is particularly preferable for the diameter of the openings in question to be selected to be smaller than the diameter of the reaction chamber openings, in order to substantially avoid the temperature artefacts resulting from differences in emissivity which may be caused by the material of the reaction chambers (for example stainless steel) possibly also being recorded by the thermal camera.

The mask is preferably arranged between the reaction chambers and the thermal camera, in which context it is also conceivable to use a plurality of identical or different thermal cameras.

The thermal camera is preferably one or more IR thermal cameras which can be used for spatially resolved determination of the resulting temperature difference between active materials and their surroundings or inactive materials. The measurement results from the thermal camera may be processed, for example, by means of a data processing unit or a computer, which form part of an analysis unit of the apparatus according to the invention, in such a way that resolution at the level of individual reaction chambers is possible.

The product discharge streams from individual reaction chambers may then, preferably following evaluation of the measurement results from the thermal camera, be subjected to further analysis, for example mass spectrometry, gas chromatography, Raman spectroscopy and Fourier transform (FT-IR) spectroscopy, individually or as a combination of two or more of these analysis methods. However, it is preferable to use mass spectrometry and/or gas chromatography. Further suitable analysis combinations include IR thermography/GC-MS, IR thermography/Raman spectroscopy, IR thernography/dispersive FT-IR spectroscopy, colour detection using chemical indicator/MS, colour detection using chemical indicator/GC-MS, colour detection using chemical indicator/dispersive FT (Fourier transform)-IR spectroscopy, electronic or electrochemical sensors and others. Further details concerning combined analysis methods are given in DE-A 100 12 847.5.

Moreover, the measurement results obtained can be corrected for the background radiation occurring under reaction conditions with the aid of the data processing unit as part of the analysis unit of the apparatus according to the invention. Details in this regard are given in WO 99/34206.

Furthermore, the apparatus as described above has at least one gas inlet unit. There are no particular constraints with regard to the design of the at least one gas inlet unit, provided that the gas flowing in through it is passed into the gas space via the plurality of reaction chambers.

It is preferable for the gas to be introduced in such a manner that it is distributed uniformly, particularly preferably uniformly and simultaneously, over all the reaction chambers.

Accordingly, in a preferred embodiment of the present invention, the at least one gas inlet unit is arranged in such a manner that the gas which flows in is distributed radially into the gas space.

In one embodiment of the present invention, the gas inlet unit has a gas ring which, in addition to at least one gas feed element through which the gas is fed to the gas ring, has any desired number of gas inlet elements, by means of which the gas can be introduced radially into the gas space via the reaction chambers.

In one particularly preferred embodiment, the gas inlet unit has a gas ring which, in addition to the at least one gas feed element through which the gas is fed to the gas ring, also has 1 to 100, preferably 2 to 25, particularly preferably 4 to 15 gas inlet elements, as desired, but preferably distributed uniformly over the gas ring.

Gas inlet elements may, for example, be tubular formations located at or in the gas ring, but may also be recesses in the gas ring of all types known to the person skilled in the art in this context, such as channels in the general sense of the present document.

In one preferred embodiment of the invention, the gas ring has 12 uniformly distributed bores, which are preferably of concentric design.

In one particularly preferred embodiment, the gas ring has a gas feed element and any desired number of gas inlet elements, with both elements being round in cross section and the sum of the diameters of the gas inlet elements being less than or equal to the diameter of the gas feed element.

Furthermore, all the gas inlet elements can be fed with gas individually or together, successively or simultaneously and may have means for metering the gas quantity and means for heating and/or cooling the gas flowing through them.

There are no constraints with regard to the materials which are possible for the gas ring and the gas elements, provided that the material selected is inert with respect to the gas coming into contact with it. The same materials which have already been listed in the context of the present document for use for the reactor element, preferably metals or metal alloys, particularly preferably stainless steels, can also be used for the gas ring.

Accordingly, the present invention also relates to an apparatus as described above in which the at least one gas inlet unit is arranged in such a manner that the gas which flows in is distributed radially into the gas space via the plurality of reaction chambers.

The gas outlet unit of the apparatus according to the invention may be provided and configured in the same way as the gas inlet unit which has just been described, the only functional difference being that it is used to discharge the gas from the off-gas space. The off-gas flow can be discharged in all ways known to the person skilled in the art, for example can be sucked out by the generation of subatmospheric pressure, discharged by the application of a superatmospheric pressure within the reactor element, preferably within the off-gas unit.

However, it is also possible for the provision and construction of the gas inlet unit and gas outlet unit to differ.

Furthermore, the reactor element has at least one heating unit. The reactor element of the apparatus according to the invention is heated in a suitable way by the at least one heating unit.

The at least one heating unit may be arranged in recesses directly at the reactor element or may preferably form part of the restriction unit.

Accordingly, the present invention also relates to an apparatus as described above in which at least one restriction unit has at least one heating unit.

It is preferable for the at least one heating unit to be integrated within the restriction unit in such a manner that the latter has recesses, the number, position and direction of which preferably correspond to those of the channels within the restriction unit leading from the reaction chambers.

There are no constraints with regard to the design of the heating unit, provided that it is suitable for sufficient heating of the reactor element. The at least one heating unit may comprise heating elements known to the person skilled in the art, for example heating wires, heating coils, heating cartridges or channels suitable for heating which can be fed with heat-transfer media, such as gases, liquids, solutions or melts.

It is also possible for both the gas inlet unit and the gas outlet unit to have at least one heating unit which can be used to heat the reaction gas flowing in and out, respectively.

The reaction gas flowing into the reactor element may in this case already be preheated by the at least one heating unit located in the gas inlet unit and can then be brought to the reaction temperature in the reactor element. However, it is also possible for the reaction gas flowing in to be brought to reaction temperature solely by means of the heated reactor element.

The advantage of heating the reaction gas to the final reaction temperature only once it is inside the reactor element is firstly that an undesirable reaction of the reaction gas with materials which are in contact with the reaction gas on its path into the reaction chamber is avoided and secondly that the length of the gas feed in combination with the heating power of the heating unit makes it possible to perform targeted heating of the reaction gas in such a manner that the reaction temperature is only reached when the reaction gas enters the reaction chamber or just beforehand, so that only the catalyst sample reacts with the reaction gas.

The heating elements located within the heating unit are preferably one or more electrical heating coils. It would also be conceivable to use channels with heated fluid flowing through them, the arrangement of which channels corresponds to that of the heating elements or, for example, to use heating cartridges or alternatively an active supply of heat from heating elements of the heating unit arranged outside the reactor element.

Brass is preferably used as material for the heating elements which have the at least one heating unit.

The heating elements which include the heating unit are preferably arranged between a matrix of recesses within the restriction unit. The recesses preferably correspond to the number of channels leading from the reaction chambers which are present in the restriction unit.

The heating elements are located within the heating unit, preferably in grooves which are, for example, U-shaped in cross section. The groove cross section is in this case dimensioned in such a way that it is preferably similar to that of the heating elements, so that after the heating elements have been laid in the grooves, the heating elements do not project above the surface of the heating unit. It is particularly preferable for the heating elements to be located in meandering recesses which extend symmetrically around the vertical recesses (channels), since this arrangement allows a substantially uniform distribution of heat.

For uniform distribution of heat, it is also possible for the heating unit to have at least one heat distributor. This may, for example, be fitted in the form of a thin disc on just one outer side, a plurality of outer sides or all the outer sides of the heating unit. It is preferable for a heat distributor to be fitted at least on the side facing the reactor chambers, so that it serves for uniform distribution of the heat transferred by the heating elements of the heating unit to the reaction chambers in the reactor element.

In a further embodiment of the present invention, it is preferable to use a heating unit within which preferably at least two identical or different heating elements are used, preferably arranged in one plane. It is particularly preferable for the heating elements to be arranged in such a manner that one heating element is rotated through preferably 90 degrees with respect to the other.

The heat distributor facing the reactor chambers preferably has recesses, which preferably correspond to the number, position and direction of the channels inside the restriction unit which lead vertically from the reaction chambers. The heat distributor preferably consists of a material with a high thermal conductivity, such as for example brass, copper, steel or iron.

Furthermore, the apparatus according to the invention has at least one gas outlet unit, which is preferably in direct contact with the at least one off-gas unit.

There are no constraints with regard to the design of the at least one gas outlet unit, provided that it can be used to discharge the gas collected in the off-gas space from the reactor element.

In general terms, the gas outlet unit is of substantially analogous construction to the gas inlet unit described above, except that it is used to discharge the gas from the off-gas space, rather than to supply the gas.

Therefore, the gas outlet unit has a gas ring which, in addition to at least one gas discharge element, has any desired number of gas outlet elements, which can be arranged analogously to the above-described gas inlet elements of the gas inlet unit.

In one preferred embodiment of the invention, the at least one gas outlet unit is arranged in such a manner that the gas flowing out can be discharged radially via the at least one off-gas space.

Accordingly, the present invention also relates to an apparatus as described above, in which the at least one gas outlet unit is arranged in such a manner that the gas inside the off-gas space (42) is discharged radially from the at least one off-gas space.

The at least one off-gas unit on one side adjoins the restriction unit and is used to combine the individual reaction gas streams (reaction gas from the individual reaction chambers) in at least one off-gas space.

The off-gas unit and the off-gas space can be produced from all materials known to the person skilled in the art for this purpose, for example from the materials listed for the reactor element in the present document, but preferably from steel, particularly preferably from V2A or V4A steel.

According to the invention, the apparatus has an off-gas unit with a plurality of membranes, and at least one positionable probe, such as for example a capillary, capillary system or a positionable sensor element.

With a positionable probe of this type, it is possible to selectively gain access to the outgoing product stream of an individual channel through a membrane or, if a plurality of positionable probes are used, through a plurality of membranes and then to analyze the products using one or more analysis methods.

Accordingly, the invention also relates to an apparatus as described above which has at least one off-gas unit with a plurality of membranes.

Furthermore, the invention also relates to an apparatus as described above which has at least one positionable probe.

It is also conceivable for a probe to have direct access to an outgoing product stream without the use of a membrane if the probe can be connected in a gastight manner to an individual channel using other suitable means. It is also possible for the probe to be introduced into an outlet element which is located on that side of the at least one channel which faces the off-gas unit, thereby enabling the off-gas to be removed directly from the at least one channel. This is also possible if the at least one channel has at least one capillary of any desired internal diameter, since the outlet element is specifically dimensioned to be suitable for the introduction of a probe and that end of the capillary which faces the off-gas unit opens out into that part of the outlet unit which faces the at least one channel.

Furthermore, it is also possible for a plurality of probes to be used simultaneously for a plurality of outgoing product streams, which probes are displaced to the channels which are connected to reaction chambers with particularly active catalysts for further analysis according to the evaluation of the IR thermography.

The probes can preferably be positioned in two directions, but particularly preferably in three directions. To achieve even more efficient analysis of the individual outgoing product streams, it is also possible to provide a plurality of probes for an outgoing product stream from a channel. This allows simultaneous analysis of the outgoing product stream from a channel using a plurality of different analysis methods, for example mass spectrometry, gas chromatography, GC-MS, Raman spectroscopy, infrared spectroscopy, UV-VIS spectroscopy, NMR, fluorescence, ESR, NMR and ESR tomography and Mössbauer spectroscopy.

Further suitable analysis combinations include IR thermography/GC-MS, IR thermography/Raman spectroscopy, IR thermography/dispersive FT-IR spectroscopy, colour detection using chemical indicator/MS, colour detection using chemical indicator/GC-MS, colour detection using chemical indicator/dispersive FT-IR spectroscopy, analysis with electronic or electrochemical sensors and others.

The positionable probe is preferably connected to the analysis unit by connecting means.

This analysis unit may have either one analysis appliance or a plurality of analysis appliances, such as for example a mass spectrometer and a gas chromatograph. In this context, the connecting means are preferably pipelines, flexible tubes made, for example, from Kapton, PE capillaries, glass capillaries and/or quartz capillaries, as well as Teflon capillaries and/or capillaries made from stainless steels, which have the function of transferring the outgoing product stream, or part of it, to the analysis unit.

The connecting means used may also be a bundle of capillaries which transfers the outgoing stream, or part of it, from one or more positionable probes to a plurality of analysis units. It is also possible not only to provide a plurality of individual positionable probes, but rather for one positionable probe to have a bundle of capillaries, with the capillaries within the bundle of the positionable probe being connected to a connecting means, likewise in the form of a bundle of capillaries, in order to pass on the outgoing stream, divided between the individual capillaries of the bundle, preferably to in each case different analysis units. In this context, it is in each case preferable for one capillary of the bundle of capillaries to be connected to one analysis unit.

The positionable probe is preferably connected to a control unit which is connected to a data processing unit or a computer. This data processing unit evaluates the measurement results from preferably a thermal camera and uses the control unit to displace the positionable probe accordingly to the channels within the restriction unit which are connected to those reaction chambers in which the thermal camera has once again identified active catalysts. This allows effective testing by further analysis of outgoing product streams only from active catalysts.

The efficiency can be improved further, for example, by using a plurality of positionable probes or by parallel analysis using a plurality of analysis methods.

It is also conceivable to use a plurality of thermal cameras while allowing even finer resolution of the temperature differences between catalyst material and surroundings or inactive materials.

The membranes may be provided as a simple perforated mask. Furthermore, the perforated mask may be provided with one or more septa or with means for opening and closing the individual holes, for example similar to a camera shutter. Suitable membrane materials include, for example, silicone septa or temperature-resistant plastics, such as for example Kapton or Teflon.

In one preferred embodiment, the membranes of the off-gas unit are configured as a simple perforated mask, in which case it is preferably additionally possible to provide a pump in order, for example, to generate a subatmospheric pressure in the off-gas unit laterally or radially via the gas outlet unit. A design of this nature can therefore substantially ensure that it is impossible for there to be an uncontrolled escape of reaction gas.

For selective analysis of gaseous substances from the respective reaction chambers, it is possible for the apparatus-according to the invention to have at least one multiport valve.

By way of example, one or more multiport valves can be used to distribute the outgoing product stream from a reaction channel between a plurality of analysis appliances. It is therefore also possible to combine selected outgoing product streams. In this context, it is possible for the individual outgoing streams of individual channels, a plurality of channels or all channels to be removed separately and then analyzed separately via a valve circuit.

The individual components of the apparatus according to the invention as described above can be held together, for example, by holding and/or connecting means.

The holding means are preferably annular turned parts, in which case, for example, an upper holding element fixes the transparent cover on one side of the apparatus, and a lower holding element on the other side may preferably be used, for example, to receive the connecting elements.

There are no particular constraints on the material used for the holding elements, provided that the materials used are able to withstand the loading to which the holding elements are exposed. It is preferable to use metals or metal alloys, such as for example brass, aluminium and stainless steels, such as for example those in accordance with DIN 1.4401, DIN 1.4435, DIN 1.4541, DIN 1.4571, DIN 1.4573, DIN 1.4575, DIN 2.4360/2.4366, DIN 2.4615/2.4617, DIN 2.4800/2.4810, DIN 2.4816, DIN 2.4851, DIN . 2.4856, DIN 2.4858, DIN 1.4767, DIN 1.4401, DIN 2.4610, DIN 1.4765, DIN 1.4847 and DIN 1.4301. It is particularly preferable to use V2A or V4A steel. It is also conceivable to use ceramics. Both holding elements have recesses, preferably in the form of through-bores, preferably for receiving the connecting elements.

The upper holding element is used in particular to fix an IR-transmitting material, preferably in the form of a disc. There are no particular constraints on the choice of materials used for this disc, provided that the materials selected can be produced in the desired dimensions and are IR-transparent. The disc, preferably a silicon wafer, therefore serves primarily in particular as an IR-transparent window, it being possible also to use other materials, such as for example sapphire, zinc sulphide, barium difluoride and sodium chloride, Al₂O₃, CaF₂, Si, Ge, GaAs, CdTe, ZnSe, quartz glass, KRS-S, IKS materials and IG materials. However, it is preferable to use sapphire and particularly preferable to use silicon. It is also possible to use a combination of the abovementioned materials. The disc, which is particularly preferably in the form of a silicon wafer, on one side adjoins the upper holding element and on the other side adjoins the reactor element.

The upper holding element, provided as an optional element of the apparatus, may furthermore be used, for example, for sealing purposes and/or can use angles/bevels to prevent undesired infrared reflections for certain thermal camera positions. An embodiment of this type, by way of example, avoids feedback.

The lower holding element terminates the apparatus on the opposite side from the upper holding element. It is connected to the off-gas unit and, together with the upper holding element, ensures a gastight connection between all the units located between them. Screw connections are preferably used to hold the assembly together.

The seal between the individual units is achieved as a result of polished surfaces in each case adjoining one another, with additional sealing if necessary being provided by graphite. The function of the lower holding element may also be performed by the off-gas unit, with the most important functions of the lower holding element then being integrated in the off-gas element.

The primary function of the lower holding element is to fix the off-gas unit and if appropriate to receive elements of analysis devices. Moreover, it, together with the upper holding element, may also have a holding function for the other units of the apparatus.

The lower holding element, likewise as an optional element of the apparatus, may furthermore be used, for example, as a seal, for gas extraction (e.g. radial gas extraction), as a capillary guide and for positioning a grid for image detection, for example of the individual holes.

The connecting elements used are preferably nuts and bolts. Furthermore, it is also possible to use other clamping elements, such as clamping springs, or connecting elements on the preferably annular components similar to or in the form of a bayonet closure. Of course, it is also possible to combine various connecting elements within the apparatus according to the invention.

One further possibility for connecting the individual units to one another consists in pressing all the components into a common frame.

On account of the structural configuration of the apparatus according to the invention as described above, this apparatus, by virtue of the fact that it can be scaled and expanded as desired, is particularly suitable for testing a large number of catalysts in parallel or successively.

Accordingly, the present invention also relates to an apparatus as described above which is suitable for parallel or sequential testing a number of from 50 to 1000, preferably from 100 to 5000, particularly preferably from 150 to 1000, of potential catalysts.

The apparatus according to the invention is preferably used to carry out catalytic tests, in particular for analysis using infrared thermography and at least one further analysis method. Carrying out catalytic tests in this way by means of two different analysis methods is described, for example, in DE-A 10012847.5, to which reference is made for further details. It is particularly preferable for the apparatus to be used for testing heterogeneous catalyst systems as building blocks of a material library, in particular organometallic systems, organic substances, e.g. pharmacological active ingredients, polymers, composite materials, in particular those composed of polymers and inorganic materials. The process according to the invention can in principle be applied to all fields of technology in which formulations, i.e. compositions with more than one constituent, are produced and investigated for their useful properties. Examples of application areas outside materials research include pharmaceutical formulations, formulations of foods and food supplements, feeds and cosmetics.

Accordingly, the present invention also relates to the use of an apparatus as described above for carrying out catalytic tests, in particular for analysis using infrared thermography and at least one further analysis method, on building blocks of a material library.

The term “material library” used in the context of the present invention indicates an arrangement of at least two, preferably up to 10, more preferably up to 100, in particular up to 1000 and more preferably up to 100,000 building blocks which are located in at least two different, separate reaction chambers of the reactor element.

The term “building block” refers to an individual defined unit which is located in the respective separate reaction chambers of the reactor element and may comprise one or more components.

The building blocks to be tested in the above sense are preferably non-gaseous substances, such as for example solids, liquids, sols, gels, wax-like substances or substance mixtures, dispersions, emulsions, suspensions and solids, particularly preferably solids. The building blocks used in the context of the invention may be molecular or nonmolecular chemical compounds or formulations or mixtures or materials, in which context the term “nonmolecular” defines substances which can be continuously optimized or changed, unlike “molecular” substances, whose structural configuration can only be changed by varying between the discrete states, i.e., for example, the variation of a substitution pattern.

The building blocks within the material library may be identical to or different from one another, the latter option being preferred; however, when optimizing test or reaction or process parameters, it is also eminently possible for the substance library to comprise two or more identical substances or to consist exclusively of identical substances.

The apparatus according to the invention therefore ensures that the catalyst samples are completely accessible under reaction conditions through the use of a thermal camera, with simultaneous complete physical separation between the surroundings and the reaction gas. Furthermore, it as far as possible shields the thermal radiation of the apparatus material which could be superimposed on the temperature differences between catalyst material and surroundings.

The apparatus (reactor) according to the invention can be used to simultaneously apply two or more analysis methods, such as for example thermography and a further method, such as for example mass spectrometry, GC or GC-MS, for a catalytic test.

The apparatus according to the invention therefore makes it possible, by using the thermal camera, to quickly identify active building blocks, e.g. catalysts, by detecting a temperature change and, in a second step, to selectively determine and quantify the products in the outgoing stream of these building blocks, e.g. catalysts, by using, for example, mass spectrometry or gas chromatography. In this way, it is possible to test far more catalysts within a very short time than with the methods which have been disclosed hitherto.

One embodiment of the present invention will now be explained with reference to the appended drawing, in which:

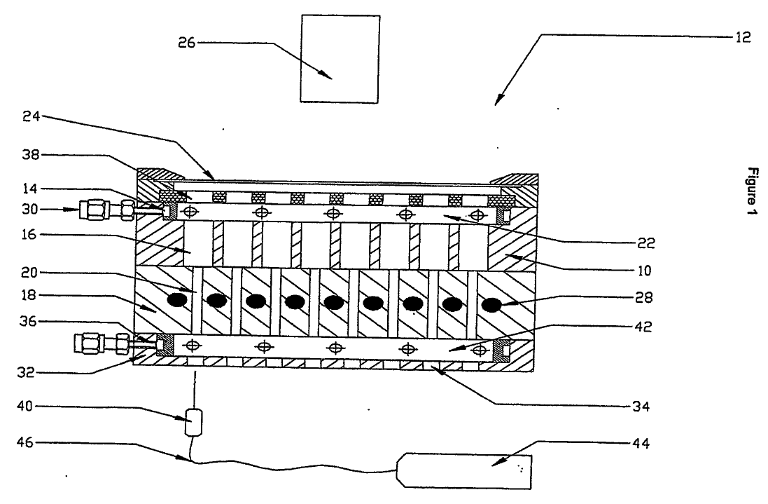

FIG. 1 shows a diagrammatic arrangement of the apparatus according to the invention for carrying out catalytic tests.

As illustrated, the reaction gas (30) is fed to the gas space (22) of the reactor element (10) through a gas inlet unit (14). The reaction gas (30) is distributed, via the gas space (22), between the plurality of reaction chambers (16). The catalyst sample to be tested is located in suitable receiving means (not shown) within each reaction chamber. In the reaction chambers (16), the reaction gas (30) reacts with the catalyst samples and then flows out of the reaction chambers (16) into the channels (20) within the restriction unit (18), which run vertically from the reaction chambers (16) towards the off-gas unit (32). In addition to the channels (20), the restriction unit (18) has a heating unit (28). The gas flowing from the reaction chambers (16) (i.e. the outgoing product stream) is collected in an off-gas space (42) and discharged from the off-gas unit (32) through a gas outlet unit (36).

Furthermore, the off-gas unit (32) is provided with membranes (34), through which a positionable probe (40) can gain selective access to the outgoing product stream of a channel (20).

It is also possible for the probe (40) to be introduced directly into an individual channel of the channels (20) in order to be able to gain direct access to the outgoing product stream from this individual channel.

The positionable probe (40) is connected to the analysis unit (44) by connecting means (46).

The apparatus (12) according to the invention also has a thermal camera (26) which is located on that side of the reactor element (10) which faces the reaction chambers (16). The reactor element (10) is covered in the direction of the thermal camera (26) by a mask (38). This mask (38) is covered by an IR-transparent cover (24) in the direction of thermal camera (26). The thermal camera (26) is in contact with a data processing unit (not shown) of the analysis unit (44) via connecting means (not shown).

This data processing unit (not shown) of the analysis unit (44) evaluates the measurement results from the thermal camera (26) and displaces the positionable probe (40) to the channels (20) which are connected to those reaction chambers (16) in which active catalysts have in turn been identified by the thermal camera (26). The probe (40) gains access to the product stream from one of the active catalysts and then uses one or more analysis methods to analyze the products contained therein.

### LIST OF REFERENCE SYMBOLS

10—Reactor element
12—Apparatus according to the invention
14—Gas inlet unit
16—Reaction chambers
18—Restriction unit
20—Channels
22—Gas space
24—IR-transparent cover
26—Thermal camera
28—Heating unit
30—Reaction gas
32—Off-gas unit
34—Membrane
36—Gas outlet unit
38—Mask
40—Positionable probe
42—Off-gas space
44—Analysis unit
46—Connecting means

1-15. (canceled)

16. An apparatus for simultaneously and/or successively carrying out at least two catalytic tests, comprising:
a reactor element, which includes at least one gas inlet unit, a plurality of reaction chambers, and at least one restriction unit, the at least one restriction unit configured to have a plurality of channels, which are arranged such that at least one reaction chamber is in direct contact with at least one channel of the at least one restriction unit.

17. An apparatus according to claim 16, in which the plurality of channels have identical geometries, the geometry being determined at least by the length and the cross section of the channels.

18. An apparatus according to claim 16, in which the plurality of channels have different geometries, the geometry being determined at least by the length and the cross section of the channels.

19. An apparatus according to claim 16, in which at least one channel of the plurality of channels has at least one capillary.

20. An apparatus according to claim 19, in which the at least one capillary is exchangeably connected to the at least one channel of the plurality of channels.

21. An apparatus according to claim 16, in which the at least one restriction unit can be exchanged independently of other components of the apparatus.

22. An apparatus according to claim 16, in which the at least one gas inlet unit is arranged such that gas that flows in is distributed radially into a gas space via the plurality of reaction chambers.

23. An apparatus according to claim 16, in which at least one gas outlet unit is arranged such that the gas inside an off-gas space is discharged radially from the off-gas space.

24. An apparatus according to claim 16, which has at least one IR-transparent cover.

25. An apparatus according to claim 16, in which the at least one IR-transparent cover has a silicon wafer arranged between the plurality of reaction chambers and at least one thermal camera.

26. An apparatus according to claim 16, which has at least one mask with a uniform IR emissivity.

27. An apparatus according to claim 16, in which the at least one restriction unit has at least one heating unit.

28. An apparatus according to claim 16, which has at least one off-gas unit with a plurality of membranes.

29. An apparatus according to claim 16, which has at least one positionable probe.

30. Use of an apparatus according to claim 16 for carrying out catalytic tests, for analysis using infrared thermography and at least one further analysis method, on building blocks of a material library.
